(19) United States
(12) Patent Application Publication
(10) Pub. No.: US 2022/0198141 A1
(43) Pub. Date: Jun. 23, 2022

(54) SYSTEM AND METHOD FOR IDENTIFYING AND DISPLAYING INFORMATION RELATED TO AN OFF SCREEN PLOT ELEMENT OR CHARACTER IN A MEDIA STREAM

(71) Applicants: Joanne Hudson, Redding, CT (US); Spencer C. Eldridge, Reddding, CT (US)

(72) Inventors: Joanne Hudson, Redding, CT (US); Spencer C. Eldridge, Reddding, CT (US)

(21) Appl. No.: 17/332,113

(22) Filed: May 27, 2021

Related U.S. Application Data
(60) Provisional application No. 63/162,856, filed on Mar. 18, 2021.
(60) Provisional application No. 63/128,034, filed on Dec. 19, 2020.

(51) Int. Cl. G06F 40/279; H04N 5/265; G06K 9/00; H04N 21/234; H04N 21/81

(52) U.S. Cl. CPC G06F 40/279; H04N 5/265; G06K 2209/27; H04N 21/23418; H04N 21/8133; G06K 9/00751

(57) ABSTRACT

A method for identifying and displaying one or more of a plot element and a character in a media stream includes identifying a name of the plot element or character in a portion of the media stream, determining if the identified name is a name of an off screen plot element or character, and if the identified name is a name of an off screen plot element or character, displaying information related to the off screen plot element or character on a user terminal.

### FIELD

The disclosed exemplary embodiments are directed to streaming media, and in particular to creating pictorial subtitles while streaming video.

### BACKGROUND

There are presently available services that provide images and biographies of actors while characters they portray are displayed on screen. There are currently no services that display one or more of character images, character biographies, plot element images, and information related to plot elements while the characters and plot elements are referred to, but are off screen.

### SUMMARY

The disclose embodiments are directed to a method and system for identifying off screen plot elements and characters mentioned in a media stream, displaying images of the mentioned off screen plot elements and characters, and displaying information related to the mentioned off screen plot elements and characters.

In at least one aspect, the disclosed embodiments are directed to a method for identifying and displaying one or more of a plot element and a character in a media stream, including identifying a name of the plot element or character in a portion of the media stream, determining if the identified name is a name of an off screen plot element or character, and if the identified name is a name of an off screen plot element or character, displaying information related to the off screen plot element or character on a user terminal.

Identifying the name of the plot element or character in the portion of the media stream may include utilizing a Bidirectional Encoder Representations from Transformers (BERT) based named entity recognition model to identify whether the name in the portion of the media stream is a proper name.

Determining if the identified name is a name of an off screen plot element or character may include utilizing a machine learning model to determine if the proper name is a proper name of an off screen plot element or character; and upon determining that the proper name is a name of an off screen plot element or character, querying a database service to retrieve the information related to the off screen plot element or character for display on the user terminal.

Querying the database service to retrieve the information related to the off screen plot element or character may include scraping names, images, metadata, or other information about the off screen plot element or character from the database service.

Displaying information related to the off screen plot element or character, may include displaying at least one image of the off screen plot element or character.

Displaying information related to the off screen plot element or character, may include displaying one or more of the name and metadata of the off screen plot element or character.

Displaying information related to the off screen plot element or character may include displaying the information related to the off screen plot element or character within the media stream.

Displaying information related to the off screen plot element or character may include displaying the information related to the off screen plot element or character separate from the media stream.

Displaying information related to the off screen plot element or character may include displaying the information related to the off screen plot element or character on a first user terminal while displaying the media stream on a second user terminal.

In another aspect, the disclosed embodiments are directed to a system for identifying and displaying one or more of a plot element and a character in a media stream, including an application server configured to identify a name of the plot element or character in a portion of a media stream, determine if the identified name is a name of an off screen plot element or character, and retrieve information related to the off screen plot element or character. The system also includes at least one user terminal and a plot element and character recognition application processor configured to receive the information related to the off screen plot element or character and display the information on the at least one user terminal.

### BRIEF DESCRIPTION OF THE DRAWINGS

FIG. 1 shows a schematic illustration of a system according to the disclosed embodiments;

FIG. 2 shows a general flow diagram of the operations of the disclosed system;

FIG. 3 shows a detailed diagram of the operations of the disclosed embodiments;

FIG. 4 shows an exemplary Bidirectional Encoder Representations from Transformers model according to the disclosed embodiments;

FIG. 5 shows an exemplary machine learning model according to the disclosed embodiments; and

FIG. 6 shows another flow diagram 600 illustrating operations of the disclosed embodiments.

### DETAILED DESCRIPTION

The aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

For purposes of the present disclosure, the following acronyms and definitions are applicable:
BERT—Bidirectional Encoder Representations from Transformers.
Characters—persons or animated beings.
ML—Machine Learning.
NER—Named Entity Recognition
NLP—Natural Language Processing.
Off screen—not visually present:
Plot elements: structures or other non-sentient objects.
OTT—Over The Top.

The disclosed embodiments are directed to a system and method using NLP and ML technologies combined with OTT technology to create pictorial subtitles for off screen plot elements and characters mentioned in a media stream. The system may operate to identify and display off screen plot elements and characters as they are mentioned in real time or near real time to provide the viewer with a visual cue as to whom or what is being mentioned. The disclosed embodiments may also operate to display additional information about off screen plot elements or characters upon demand.

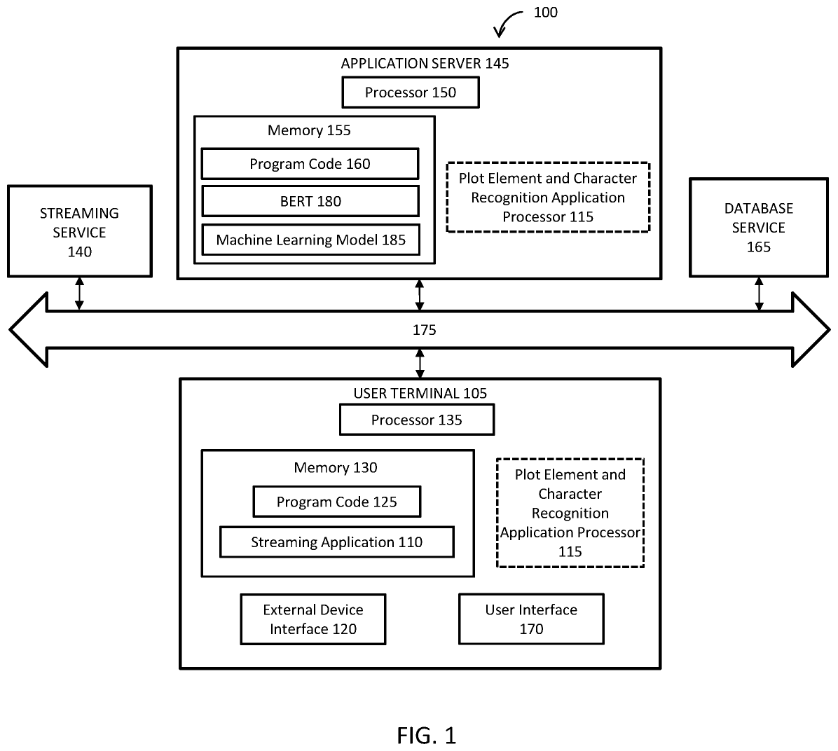

FIG. 1 shows a schematic illustration of an exemplary system 100 according to the disclosed embodiments. System 100 may include at least one user terminal 105, a streaming service 140, an application server 145, and a database service 165. The user terminal 105 may operate a streaming application 110 that provides content from the streaming service 140 to the user terminal 105 and, in some embodiments, may include a plot element and character recognition application processor 115 that interacts with the application server 145 to provide information about the content to the application server 145, for example, through an external device interface 120 that may include a web browser. The user terminal 105 may include a user interface 170 that may further include at least a display and one or more input and output devices, for example, a virtual reality or augmented reality device, a keyboard, a mouse, a touch screen, and a voice control module.

The user terminal 105 may include for example, a desktop computer, laptop, tablet, mobile phone, or any other computing device capable of performing the functions of the disclosed embodiments. It should be understood that a user may utilize more than one and different types of the user terminals 105 to operate the streaming application 110 and the plot element and character recognition application processor 115. For example, a user may use a mobile phone as a user terminal at one point in time and later may use a tablet as a user terminal.

Each user terminal 105 may include computer readable program code 125 stored on at least one non-transitory computer readable medium for carrying out and executing the processes described herein. In at least one embodiment, the computer readable program code 125 may invoke or operate the streaming application 110 and the plot element and character recognition application processor 115. The computer readable medium may include a memory 130, and in alternate aspects, the computer readable program code 125 may be stored in one or more memories external to, or remote from, user terminal 105. Memory 130 may include magnetic media, semiconductor media, optical media, or any media which is readable and executable by a computer. The user terminal 105 may also include a processor 135 for executing the computer readable program code 125.

The streaming service 140 may be a commercially available streaming service, for example, Netflix, Amazon Prime, Hulu, Disney+, etc., or any suitable source of streaming content.

The application server 145 may include a processor 150, and memory 155 storing computer program code 160 for generally operating the server 145 to provide the system and method described herein. In some embodiments, the server 145 may be implemented by a cloud computing service, and the system and method may be provided in the form of software as a service (SaaS). Memory 155 may also be used to store details related to various streaming content previously retrieved from the database service 165 for provision to the plot element and character recognition application processor 115.

In some embodiments, the plot element and character recognition application processor 115 may be included as part of the application server 145, and as mentioned above, in some embodiments the plot element and character recognition application processor 115 may be part of the user terminal 105. The plot element and character recognition application processor 115 may include computer readable program code stored on at least one non-transitory computer readable medium for carrying out and executing the functions performed by the plot element and character recognition application processor described herein. The computer readable medium may include a memory, and in alternate aspects, the computer readable program code may be stored in one or more memories external to, or remote from, the application server 145 or the user terminal 105. The plot element and character recognition application processor 115 may also include a processor for executing the computer readable program code. It should be understood that the plot element and character recognition application processor 115 may be implemented in hardware, software, or a combination of hardware and software, and in some aspects may be implemented as part of memory 130, memory 155 or a combination of memories 130, 155.

The database service 165 system may be a commercially available service that may provide details related to various streaming content, for example, character information, plot element descriptions, plot summaries, or any other information related to streaming media content. Example database services may include fandom.com, wikia.com, etc.

The various components of the system 100, including the user terminal 105, the server 145, and the database service 165 may communicate over a network 175.

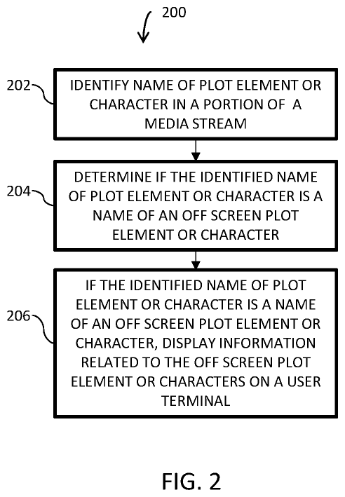

Referring to FIG. 2, in general the system 100 may operate to identify a name of the plot element or character in a portion of the media stream 202, determine if the identified name is a name of an off screen plot element or character 204, and if the identified name is a name of an off screen plot element or character 206, display information related to the off screen plot element or character on the user terminal 105.

The portion of the video stream may include, for example, one or more of a portion that incorporates closed caption or open caption information, subtitles, information in the vertical blanking interval, information encoded in the EIA-708 format, Teletext, or other data portion of the video stream, an audio portion of the video stream, or other portion that includes information about plot elements, characters or both.

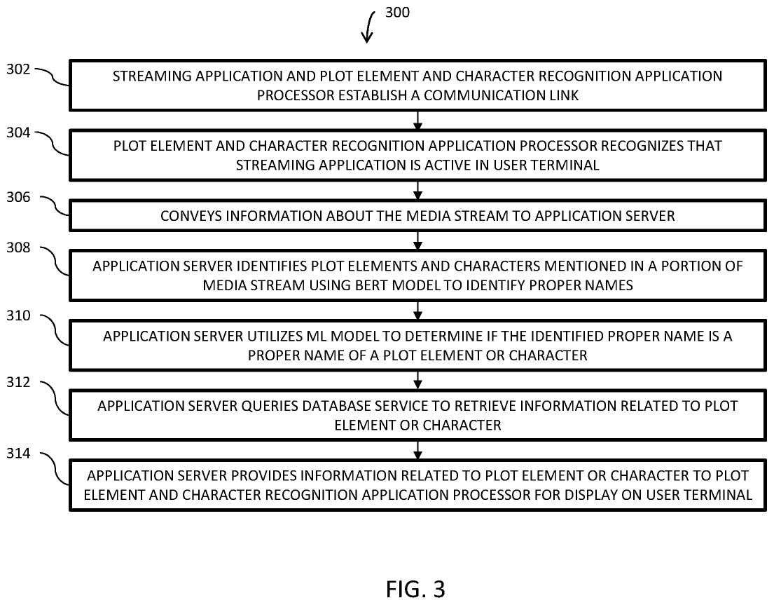

In more detailed operation 300, shown in FIG. 3, the streaming application 110 and the plot element and character recognition application processor 115 may establish a communication link as shown in block 302 between themselves in the user terminal 105 when the streaming application 110 and the plot element and character recognition application processor 115 are part of the user terminal 105, or may establish a communication link over the network 175 when they are part of the user terminal 105 and the application server 145, respectively. The plot element and character recognition application processor 115 may recognize that the streaming application 110 is active in the user terminal 105 as shown in block 304, and may convey information about the media stream presented by the streaming application 110 to the application server 145 as shown in block 306. As shown in block 308, the application server 145 may operate to identify the plot elements and characters mentioned in a portion of the media stream utilizing a BERT based named entity recognition model 180 to identify proper names mentioned in the media stream. The BERT model 180 may be similar to the model disclosed in Devlin et al. BERT: Pre-training of Deep Bidirectional Transformers for Language Understanding, arXiv:1810.04805 [cs.CL], May 24, 2019,

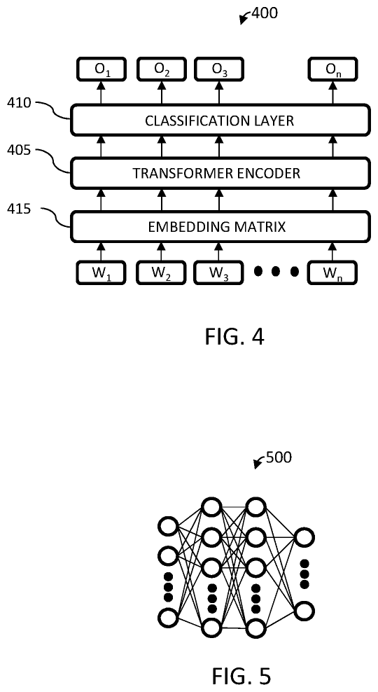

FIG. 4 illustrates an exemplary BERT model 400. The BERT model 400 generally includes a transformer encoder 405 that is referred to as bidirectional in that it reads an entire sequence of words at once. A classification layer 410 may be added on top of the encoder output, and the word vectors W₁₋ₙ may be multiplied by an embedding matrix 415 to transform them into the vocabulary dimension.

The BERT model 180 may use a Masked Language Model (MLM) pre-training objective, that may randomly mask some of the tokens from the input in order to predict the original vocabulary id of the masked word based on its context. During pre-training, the BERT model 180 may be trained on unlabeled data over the pre-training tasks to yield pre-trained parameters. The BERT model 180 may also use a next sentence prediction task that jointly pre-trains text-pair representations. The BERT model 180 may then be fine-tuned by initializing the BERT model 180 with the pre-trained parameters and fine-tuning all BERT model parameters using labeled data from downstream tasks. A NER model may be trained using BERT by feeding an output vector of each token into a classification layer that a NER label.

The application server 145 may utilize an ML model 185 to determine if the identified proper name is a proper name of a plot element or character, as shown in block 310. The ML model 185 may include one or more gated recurrent units (GRUs), long short term memory (LSTM) networks, fully convolutional neural networks (FCNs), generative adversarial networks (GANs), back propagation (BP) neural networks, radial basis function (RBF) neural networks, deep belief nets (DBN) neural networks, Elman neural networks, attention neural networks, or any machine learning model capable of performing the operations described herein.

FIG. 5 depicts an exemplary simple deep learning model 500 that may be utilized to implement the disclosed embodiments. The deep learning model 500 may be trained to recognize proper names as being proper names of a plot element or character using supervised learning techniques with a known training set.

Returning to FIG. 3, upon determining that the proper name is a name of a plot element or character, the application server 145 may query the database service 165 to retrieve information related to the plot element or character, as shown in block 312, and may provide the information related to the plot element or character to the plot element and character recognition application processor 115 for display on the user terminal 105, as shown in block 314.

In some embodiments, the plot element and character recognition application processor 115 may provide the information related to the plot element or character to the streaming application 110, for display within the media stream presented by the streaming application 110 to the user interface 170. In further embodiments, the plot element and character recognition application processor 115 may provide the information related to the plot element or character directly to the user interface 170 for display independently from the streaming application 110. In still further embodiments, the plot element and character recognition application processor 115 may provide the information related to the plot element or character directly to the user interface 170 for display by the user interface, without displaying the media stream presented by the streaming application 110 on the user terminal 105.

For example, a user may view a media stream presented by the streaming application 110 on a user terminal 105 and view information pertaining to the media stream provided by the plot element and character recognition application processor 115, in real time or near real time, within the media stream. As another example, a user may view a media stream presented by the streaming application 110 on a user interface 170 of the user terminal 105 and view information pertaining to the media stream provided by the plot element and character recognition application processor 115 on the user interface 170 separate from the media stream. As yet another example, a user may view a media stream presented by the streaming application 110 on a user interface 170 of a first user terminal 105 and view information pertaining to the media stream provided by the plot element and character recognition application processor 115 on a second user interface 170 of a second user terminal 105.

The application server 145 may optionally store the information related to the plot element or character in memory 155 for future use by the plot element and character recognition application processor 115.

In some embodiments, the mentioned plot elements and characters may be limited to off screen mentioned plot elements and characters. For example, the application server 145 may utilize the machine learning model to determine if the proper name is a proper name of an off screen plot element or character. For example, the machine learning model may utilize facial recognition techniques to determine whether a plot element or character is present within the media stream, and upon determining that the proper name is a proper name of a plot element or character not presently displayed, may query the database service 165 to retrieve information related to the off screen plot element or character, and provide the information related to the off screen plot element or character to the plot element and character recognition application processor 115 for display within the media stream presented by the streaming application 110.

Querying the database service 165 to retrieve the information may include scraping names, images, metadata, or any other information provided by the database service 165 about the off screen plot elements or characters from the database service 165.

Displaying information related to the plot elements or characters, or the off screen mentioned plot elements and characters, may include displaying at least one image of the mentioned plot elements and characters or the off screen mentioned plot elements and characters.

While the images of the mentioned plot elements and characters, off screen or otherwise, are displayed, upon demand, additional information about the mentioned plot elements and characters may also be displayed. The plot element and character recognition application 115 may recognize a user input, for example, a touch screen input, a key stroke, a gesture, a spoken command, or any suitable user interaction with the user interface 170 that may indicate an on demand request for additional information about a mentioned plot element or character. Upon recognition of the user input, the plot element and character recognition application processor 115 may request additional information about the mentioned plot element or character from the application server 145. The application server 145 may provide the additional information directly or may request the additional information from the database service 165 for provision to the plot element and character recognition application processor 115 for display by the user interface 170.

The additional information may include names, descriptions, historical information, background information, previous accomplishments, context information about the plot element and character within the media stream, or any other suitable information about the plot element and character.

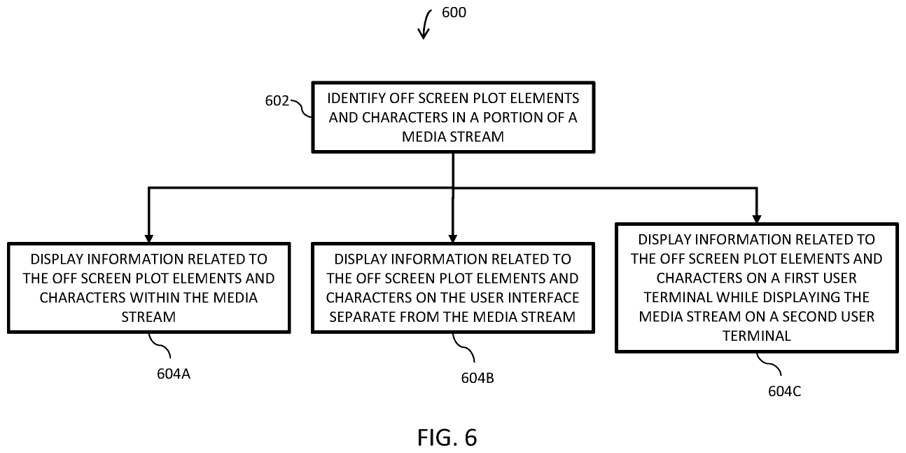

FIG. 6 shows another flow diagram 600 illustrating operations of the disclosed embodiments. As shown in block 602, the method includes identifying off screen plot elements and characters mentioned in a media stream. As shown in block 604A, the method may further include displaying within the media stream, information related to the off screen plot elements and characters. The method may also include, as shown in block 604B, displaying the information related to the off screen plot elements and characters on the user interface separate from the media stream. The method may further include, as shown in block 604C, the method may further include displaying the information related to the off screen plot elements and characters on a user terminal while displaying the media stream on a separate user terminal.

The disclosed embodiments may be advantageous for providing users with reminders about whom or what is being discussed in the media stream, and may also be helpful for overcoming user cognitive, audio, or visual deficiencies.

The various embodiments described above are provided by way of illustration only and should not be construed to limit the scope of the disclosure. For example, the principles herein apply generally to any large, standardized data set. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

Various modifications and adaptations may become apparent to those skilled in the relevant arts in view of the foregoing description, when read in conjunction with the accompanying drawings. However, all such and similar modifications of the teachings of the disclosed embodiments will still fall within the scope of the disclosed embodiments.

Various features of the different embodiments described herein are interchangeable, one with the other. The various described features, as well as any known equivalents can be mixed and matched to construct additional embodiments and techniques in accordance with the principles of this disclosure.

Furthermore, some of the features of the exemplary embodiments could be used to advantage without the corresponding use of other features. As such, the foregoing description should be considered as merely illustrative of the principles of the disclosed embodiments and not in limitation thereof.

1. A method for identifying and displaying a character in a data portion of a media stream, comprising:
identifying a name of the character in the data portion of the media stream by analyzing the data portion of the media stream utilizing a Bidirectional Encoder Representative from Transformers (BERT) based name entity recognition model;
determining that the identified name in the data portion of the media stream is a name of an off screen character utilizing a machine learning model; and
displaying a static image of the off screen character and information related to the off screen character on a user terminal.

2. The method of claim 1, wherein identifying the name of the character in the data portion of the media stream, comprises utilizing the BERT based named entity recognition model to identify whether the name in the data portion of the media stream is a proper name.

3. The method of claim 2, wherein determining that the identified name is a name of an off screen character, comprises:
utilizing the machine learning model to:
determine if the proper name is a proper name of an off screen character; and
upon determining that the proper name is a name of an off screen character, querying a database service to retrieve the static image and information related to the off screen character for display on the user terminal.

4. The method of claim 3, wherein querying the database service to retrieve the static image and information related to the off screen character, comprises scraping names, images, metadata, or other information about the off screen character from the database service.

5. (canceled)

6. The method of claim 4, wherein displaying the static image and information related to the off screen character, comprises displaying one or more of the name and metadata of the off screen character.

7. The method of claim 1, wherein displaying the static image and information related to the off screen character comprises displaying the static image and information related to the off screen character within the media stream.

8. The method of claim 1, wherein displaying the static image and information related to the off screen character comprises displaying the static image and information related to the off screen character separate from the media stream.

9. The method of claim 1, wherein displaying information related to the off screen character comprises displaying the static image and information related to the off screen character on a first user terminal while displaying the media stream on a second user terminal.

10. A system for identifying and displaying a character in a data portion of a media stream, comprising:
an application server configured to:
identify a name of the character in the data portion of the media stream by analyzing the data portion of the media stream utilizing a Bidirectional Encoder Representations from Transformers (BERT) based named entity recognition model;
determine that the identified name in the data portion of the media stream is a name of an off screen character utilizing a machine learning model; and
retrieve a static image of the off screen character and information related to the off screen character;
the system further comprising:
at least one user terminal; and
a plot element and character recognition application processor configured to receive the static image of the off screen character and the information related to the off screen character and display the static image and the information on the at least one user terminal.

11. The system of claim 10, wherein the application server is configured to identify the name of the character in the data portion of the media stream by utilizing the BERT based named entity recognition model to identify whether the name in the data portion of the media stream is a proper name.

12. The system of claim 11, wherein the application server is configured to determine that the identified name is a name of an off screen character by:
utilizing machine learning model to determine if the proper name is a proper name of an off screen character; and
upon determining that the proper name is a proper name of an off screen character, querying a database service to retrieve the static image and information related to the off screen character.

13. The system of claim 12, wherein querying the database service to retrieve the static image and information related to the off screen character comprises scraping names, images, metadata, or other information about the off screen character from the database service.

14. (canceled)

15. The system of claim 13, wherein the static image and information displayed on the at least one user terminal comprises one or more of the name and metadata of the off screen character.

16. The system of claim 10, wherein the plot element and character recognition application processor is configured to display the static image and information on the at least one user terminal within the media stream.

17. The system of claim 10, wherein the plot element and character recognition application processor is configured to display the static image and information on the at least one user terminal separate from the media stream.

18. The system of claim 10, wherein the plot element and character recognition application processor is configured to display the static image and information on a first user terminal while displaying the media stream on a second user terminal.
